(19) United States
(12) Patent Application Publication
(10) Pub. No.: US 2012/0060209 A1
(43) Pub. Date: Mar. 8, 2012

(54) NETWORK DEVICES AND AUTHENTICATION METHODS THEREOF

(75) Inventor: KUEN-LONG LEU, Hsinchu City (TW)

(73) Assignee: ACCTON TECHNOLOGY CORPORATION, Hsinchu (TW)

(21) Appl. No.: 13/224,638

(22) Filed: Sep. 2, 2011

(30) Foreign Application Priority Data
Sep. 7, 2010 (TW) 099130164

(51) Int. Cl. H04L 9/32; G06F 7/04; G06F 15/16

(52) U.S. Cl. 726/7

(57) ABSTRACT

The present invention relates to a network device and an authentication method thereof. When one network device is connected with another one, the two network devices may respectively receive and transfer an authentication reporting packet each other. Accordingly, the network devices may compare context of the received authentication reporting packet and a stored authentication type information, a digest information, and an authentication protocol information for determining whether process the following specific protocol packet according to the comparison result.

### TECHNICAL FIELD

The present invention relates to a network device and an authentication method thereof applied in data transfer layer, and more particularly, to a network device and an authentication method thereof may ensure the transmission power by the authentication information.

### TECHNICAL BACKGROUND

Nowadays, the packet formed by the transmission data in general network communication is called protocol data unit (PDU), physical of each layer adds its data on the PDU for forming the message format of the terminal system.

General speaking, protocol of Layer 2 (L2, data connection layer), for example, STP, LACP, GVRP, LLDP . . . etc., is an important protocol for maintaining network stabilization. The authentication manner of the Layer 2 is distinct from the routing protocol (for example, RIP, OSPF) of the Layer 3 (L3, network layer). The network protocol of L2 does not have the authentication manner. Therefore, any operator may optionally increase or decrease a network device of L2 in the present network, for example, the network switch, the bridge.

However, it is easy to decrease or increase the network device applied on L2 on the network. The described above may increase the convenience of the equipment line connection, but it is easy to damage the original network structure causing entire network are unstably if the design is not good. Moreover, the L2 network device with the increased equipment is used by someone who perform the malicious attack, and it also damage the network device or paralyze the network operation so as to make many troubled problems for the network administrator.

Therefore, it is worth considering for manufacturers that how to effectively control the increased network equipment so as to decrease the damage of the original network structure due to the malicious network device.

### TECHNICAL SUMMARY

The present invention provides a network device and an authentication method thereof applied in data transfer layer, which mainly uses Layer 2 communication protocol to transmit the authentication report packet for verifying the usage weight so as to ensure the network system security and stability.

The present invention discloses a network device configured to connect another network device. The network device comprises a storing unit, a packet unit and a verification module.

The storing unit is used for storing an authentication type information, a digest information and an authentication protocol information. A packet unit is used for transmitting a first authentication report packet to another network device, and receiving a second authentication report packet from the another network device. A verification module, for reading the authentication type information, the digest information and the authentication protocol information from the storing unit, and then respectively writing the authentication type information, the digest information and the authentication protocol information into an authentication type information field, a digest information field and an authentication protocol information field when the network device configured to connect the another network device, and comparing information of the authentication type information field, the digest information field and the authentication protocol information field of the second authentication report packet with the authentication information, the authentication information and the authentication protocol information in the storing unit so as to determine whether a specific protocol packet from the another network device will be processed.

The present invention provides an authentication method adaptively configured to authentication of a network device and another network device of a second layer in OSI layers, comprising: generating a first authentication report packet according to a first authentication type information, a digest information and an authentication protocol information; writing an predetermined media access control address into a destination address field of the first authentication report packet; transmitting the authentication report packet to the another network device; obtaining a second authentication type information, a second digest information and a second authentication protocol information of a second authentication report packet when receiving a authentication report packet; respectively comparing the second authentication type information, the second digest information and the second authentication protocol information with the first authentication type information, the first digest information and the first authentication protocol; and determining whether succeed on the authentication according to the comparing result.

The technology feature of the present invention is that after the network devices applying L2 are connected each other, it ensures allowable process specific network protocol via the network device used for transmitting and receiving packet, and avoids some one to use the new added network device to perform the malicious attack operation via the specific network device, and simultaneously avoids other people perform the incorrect design so as to affect the network device security and stability.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 illustrates a device structure diagram according to one embodiment of the present invention;

FIG. 2 illustrates a network device connection structure diagram according to one embodiment of the present invention;

FIGS. 3A-3C illustrate Layer 2 generic authentication protocol packet (L2GAP packet) structure used by the L2GAP according to one embodiment of the present invention; and

FIG. 4 is a flow chart illustrating the authentication method of the network device according to one embodiment of the present invention.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

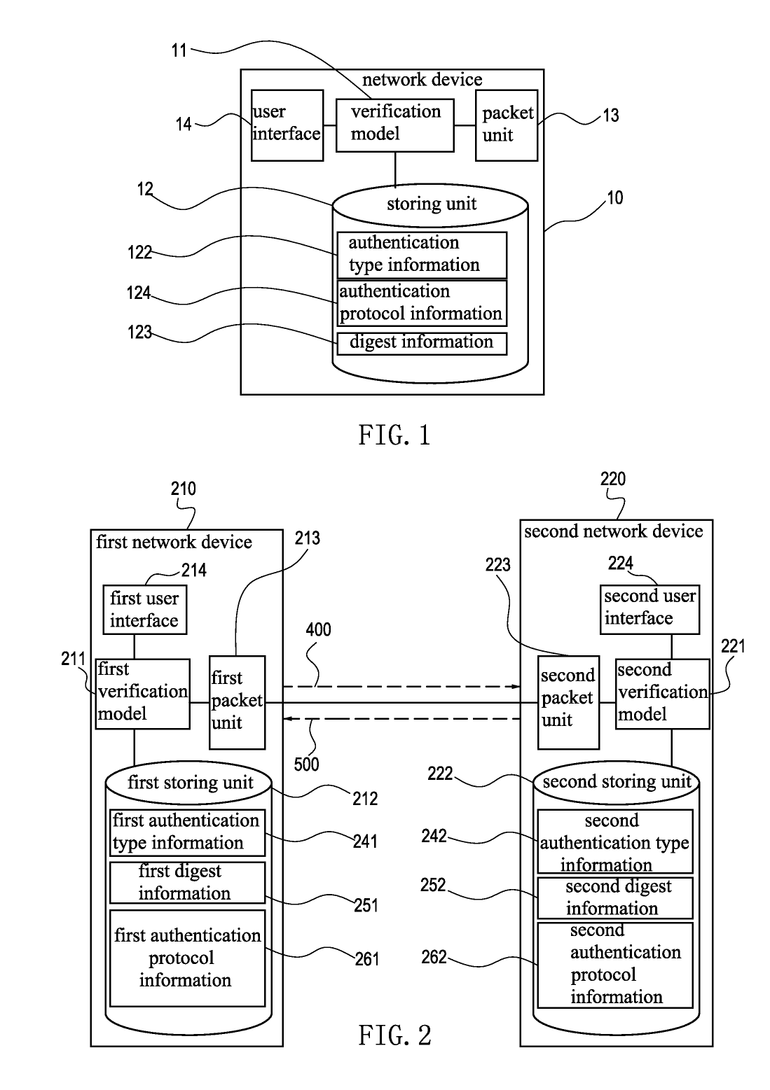

FIG. 1 illustrates a device structure diagram according to one embodiment of the present invention, and FIG. 2 illustrates a network device connection structure diagram according to one embodiment of the present invention.

In the present embodiment, a network device 10 performs the authentication with another network device according to a Layer 2 authentication protocol, and detailed of the Layer 2 authentication protocol will be described later.

The network device 10 of the embodiment of the present invention comprises a storing unit 12, a packet unit 13, a verification module 11 and a user interface 14.

The storing unit 12 stores an authentication report information (it is defined that the authentication report information is utilized to generate an information in the authentication report packet field), and the authentication report information comprises an authentication type information 122, a digest information 124 and an authentication protocol information 123. The authentication type information 122 and the authentication protocol information 123 correspond to the configuration of the network device 10. The authentication information 122 represents which type of the authentication method is utilized by the network device 10. A predetermined key code is calculated to obtain the digest information 125 according to an algorithm of the authentication type. The authentication protocol information 123 represents which type of communication protocol needs to be authenticated by the network device 10. It may set configurations of the network device 10 via the user's interface 14 so that the user may update, modify or input the authentication type information 122, the authentication protocol information 123 and the predetermined key code of the network device 10.

The verification module 11 is electrically coupled to the storing unit 12 and the packet unit 13, and transmits and receives the packet via the packet unit 13, and reads the stored information from the storing unit 12 for helping the authentication. In the embodiment, the verification module 11 is a central processing unit (CPU) and combines with the verification program of the verification operation.

FIG. 2 illustrates a network communication system of the embodiment of the present invention. As shown in FIG. 2, it represents how to perform the authentication operation between the network device of the present embodiment and another network device. In the embodiment, it will discuss the operation of a first network device 210 and a second network device 220. Additionally, the network device of the present embodiment is used in the Ethernet network architecture and transmits and/or receives the transmitted packets through the network in accordance with IEEE 802.3 standard, for example, Ethernet network switch. Therefore, the transmitted packet formats also meet the packet structure defined in the standard. However, the network device is not limited to be the Ethernet network switch mentioned above, and other network devices applied in the Layer 2 may be utilized in the present invention.

The first network device 210 comprises a first verification module 211, a first packet unit 213 and a first storing unit 212. The second network device 220 comprises a second verification module 221, a second packet unit 223 and a second storing unit 222.

The storing unit 212 and the second storing unit 222 both store an authentication report information, and respectively comprises the first and second authentication type information (241, 242), the first and second digest information (261, 262) and the first and second authentication protocol information (251, 252), etc.

The packet transmitting and packet receiving operations of the first network device 210 and the second network device 220 are performed via the first packet unit 213 and the second packet unit 223.

Specifically, the first and second authentication type information (241, 242) and the first and second authentication protocol information (251, 252) stored in the storing units (212, 222) are set arbitrarily via the user interface of each of network devices and the network device utilizes the algorithm corresponding to the predetermined key code to figure out the first and second verification information (261, 262) via the operation tool and software according to the authentication method indicated by the authentication type information. Moreover, values of the first and second authentication type (241, 242), the first and second digest information (261, 262) and the first and second authentication protocol information (251, 252) recorded in the first and second storing units (212, 222) should be the same. In addition, the first network device 210 and the second network device 220 respectively have a first user interface 214 and a second user interface 224 for respectively updating the authentication report information of the first and second network devices 210, 220 so as to set the network device configuration of the first and second network devices 210, 220.

When the second network device connects to the first network device, the first verification module 211 of the first network device 210 firstly obtains the authentication report information from the first storing unit 212 (note that the authentication report information comprises the first authentication type information 241, the first digest information 261 and the first authentication protocol information 251), and generates a first authentication report packet 400 according to the authentication report information.

The first verification module 211 may respectively write the first authentication type information 241, the first digest information 261 and the first authentication protocol information 251, which are stored in the first storing unit 212, into the authentication type field, the digest field and the authentication protocol field of the first authentication report packet 400.

The first packet unit 213 is used to transmit the first report packet 400. The first report packet 400 generated from the first verification module 211 comprises a destination address field, and a predetermined MAC address is filled therein. Specifically, the predetermined MAC address belongs to a broadcast MAC address of broadcast type or MAC address of Multicast type. Therefore, the first authentication report packet 400 brought broadcast MAC address or Multicast MAC address can be received by network device without being forwarded directly.

After the first packet unit transmits out the first authentication report packet 400 in the first network device, the second packet unit 223 in the second network device will receive the first authentication report packet 400, and then the second verification module 221 analyzes the authentication type information, the digest field and the authentication protocol field of the first authentication report packet 400 for obtaining the first authentication type information 241, the first digest information 261 and the first authentication protocol information 251 and the like. Subsequently, the second verification module 221 compares the first authentication type information 241, the first digest information 261 and the first authentication protocol information 251 with the second authentication type information 242, the second digest information 262 and the second authentication protocol information 252, which are stored in the second storing unit 222 for determining whether the specific protocol packet subsequently transmitted from the first network device 210 will be processed by the second network device. When the first authentication type information, the first digest information and the first authentication protocol information match the second authentication type information, the second digest information and the second authentication protocol information separately, it represents the authentication of the first network device is successful. Oppositely, the authentication of the first network device is failed and it determines the succeeding transmitted specific protocol packet will be ignored or be refused to be processed.

Similarly, when the second network device connects to the first network device, or receives the first authentication report packet, the second verification module 221 may obtain the authentication report information from the second storing unit 222 (It is noted that the authentication report information comprises the second authentication type information 242, the second digest information 262 and the second authentication protocol information 252), and generate a second authentication report packet 500 according to the authentication report information.

The second verification module 221 may respectively write the second authentication type information 242, the second digest information 262 and the second authentication protocol information 252, which are stored in the second storing unit 222, into the authentication type information field, the digest field and the authentication protocol field of the second authentication report packet 500.

The second verification module 221 utilizes the second packet unit 223 to transmit the second authentication report packet 500. The authentication report packet 500 includes a destination address field being filled with a predetermined MAC address. Once the first network device 210 receives the second authentication report packet 500 and then performs packet operation for the second authentication report packet 500.

The first packet unit 213 receives the second authentication report packet 500, and then the first verification module read the authentication type field, the digest field and the authentication protocol field of the second authentication report packet 500 for obtaining the second authentication type information 242, the second digest information 262 and the second authentication protocol information 252. The first verification module 211 may respectively compare the second authentication type information 242, the second digest information 262 and the second authentication protocol information 252 with the first authentication type information 241, the first digest information 261 and the first authentication protocol information 251 so as to determine whether process the succeeding transmitted specific protocol packet from the second network device 220. The determined method is described above, and therefore it will not discuss again.

From above mentioned, when the first network device 210 of the present embodiment connects to the second network device 220, it needs to receive the authentication report packets from other network devices, and allows to process the specific protocol packet after the authentication is successful. In addition, the network device also may transmit the authentication report packet itself for transmitting authentication information so as to perform the authentication of the other network devices. Thereby, it may avoid to damage or malicious attack the network device via unallowable network devices.

Subsequently, it will discuss the authentication packet structure used by the Layer 2 authentication protocol according to one embodiment of the present invention.

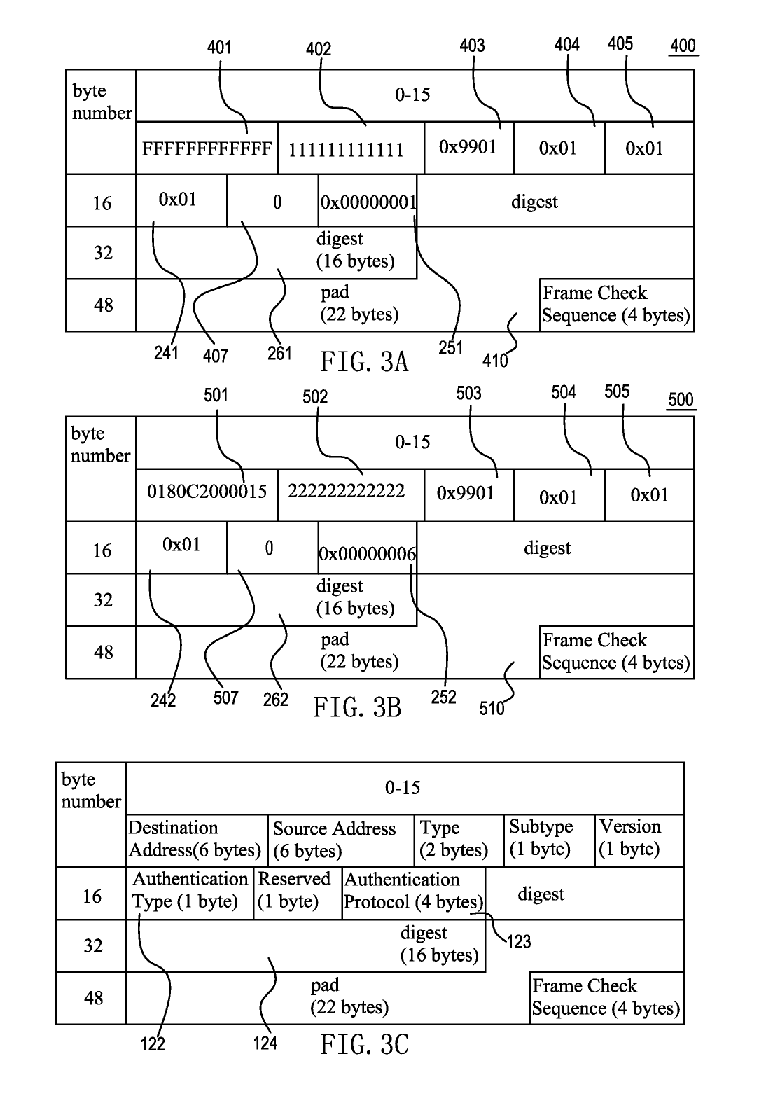

FIGS. 3A-3C illustrate Layer 2 generic authentication protocol packet (L2GAP packet) structure used by the L2GAP according to one embodiment of the present invention. In the embodiment, it assumes the authentication report packet format in FIG. 3C meets Ethernet network packet structure. FIG. 3A illustrates the first authentication report packet meets the packet format of FIG. 3C, and the FIG. 3B illustrates the second authentication report packet meets the packet format of FIG. 3C.

(1) Destination Address (take 6 bits for an example): it defines a predetermined MAC address, which is used for processing the L2GAP packet by the network device. The Destination address is a predetermined MAC address or is set by the administrator, and the destination address is an unused MAC address which is not used in defining a physical MAC address for addressing purpose in any network devices.

As shown in FIG. 3A, the destination address 401 of the first authentication report packet is predetermined as a MAC address: “FF-FF-FF-FF-FF-FF”. As shown in 3B, the destination address 501 of the second authentication report packet is predetermined as a specific multicast MAC address: “01-80-C2-00-00-15”. However, the above Broadcast MAC address and the Multicast MAC address are not limited herein.

(2) Source Address (take 6 bytes for an example): it defines a Device MAC address that is assigned to a device which transmits the authentication report packet (L2GAP packet). As shown in FIG. 3A, it assumes the Device MAC address of the first network device 210 is 11-11-11-11-11-11, and the source address 402 of the first authentication report packet is 11-11-11-11-11-11. As shown in FIG. 3B, it assumes the Device MAC address of the second network device 220 is 22-22-22-22-22-22, and the source address 502 of the second authentication report packet is 22-22-22-22-22-22.

(3) Type (take 2 bytes for an example): it defines the data type of a packet payload, which will define whether the data type of a packet payload is an authentication report packet. As shown in FIGS. 3A and 3B, it is assumed that the bytes ‘0x9901’ is defined for representing that the data type of a packet payload is the authentication report packet, but it is not limited thereto.

(4) Subtype (take 1 byte for an example): it defines the data usage of the payload. The data usage includes the report used for providing the related information about the authentication protocol. In the embodiment, the subtype 404 of the first authentication report packet and the subtype 504 of the second authentication report packet are defined as 0x01, but it is not limited herein.

(5) Version (take 1 byte for an example): it defines the version of the L2GAP. For example, 0x01 is defined as first version, 0x02 is defined as second version and so on. In the embodiment, the version of the first authentication report packet and the version of the second authentication report packet are defined as 0x01, but it is not limited herein.

(6) Authentication Type (take 1 byte for an example): the authentication type information 122 is defined as the authentication type used by L2GAP. In the embodiment, the authentication type information 122 uses Message-Digest Algorithm 5 (MD5) and defines the authentication type of MD5 as 0x01.

(7) Reserved (take 1 byte for an example): it is reserved for the unused field. In the embodiment, the value in the reserved 407 of the first authentication report packet and the value in the reserved 507 of the second authentication report packet are 0.

(8) Authentication Protocol (take 4 bytes for an example): the authentication protocol information 124 defines which type of L2GAP needs to be authenticated. Every bit in the authentication protocol information field represents a kind of L2GAP, and the value of every bit represents whether the corresponding L2GAP needs to be authenticated. For example, it assumes the authentication protocol field uses 32 bits to perform 32 bit mapping, and predetermines the first bit to represent Spanning Tree Protocol (STP), the second bit to represent Link Aggregation Control Protocol (LACP), the third bit to represent Link Layer Discovery Protocol (LLDP) and other bits represent different kinds of L2GAP, etc. It assumes the value of the bit as 0, which represents it need not to be authenticated, and it assumes the values of the bit as 1, which represents it needs to be authenticated. Oppositely, it also assumes the value of the bit as 1, which represents it need not to be authenticated, and it assumes the value of bit as 0, which represents it needs to be authenticated. For example, when the first network device only needs to perform the authentication for the STP, it merely set the value of the first bit in the authentication protocol field of the first authentication report packet as 1, and it represents “00000000000000000000000000000001₂” (the binary scale) or “0x00000001”, as shown in FIG. 3A. The second verification module 221 uses the second authentication protocol information 252 to analysis the authentication field of the first authentication report packet 400 for determining whether the both values are “0x00000001”. Moreover, when second network device 220 only needs to perform the authentication for the LACP and LLDP, it needs to set the values of the second and third bits in the authentication protocol field of the second authentication report packet 500 are 1, and it represents“00000000000000000000000000000110₂” (the binary scale) or “0x00000006”, as shown in FIG. 3B. The first verification module 211 uses the first authentication protocol information 261 to analysis the authentication protocol field of the second authentication report packet 500 for determining whether the both values are“0x00000006”. In addition, the authentication protocol predetermined bits also corresponds other bits, for example, 16 bits, 48 bits, 20 bits, 11 bits and more specific length bits or non-specific length bits, but it is not limited herein.

(9) Digest (take 16 bytes for an example): the authentication protocol information 123 is the result value generated by calculating the predetermined key via the authentication type indicated by the authentication type field. In the embodiment, the predetermined key is a predetermined Pre-share key and it obtains the result value with 16 bytes via the calculation of the MD5, wherein the result value is the digest.

(10) PAD (take 22 bytes for an example): it is used for padding the requirement, which has a payload having the each data packet, which must comprises a minimum byte number being 64 bytes on the Ethernet network. In the embodiment, the values of the pad 410 of the first authentication report packet and the pad 501 of the second authentication report packet are set as 0x00 or other values.

(11) Frame Check Sequence (FCS, take 4 bytes for an example): it mainly checks the digest correction code (that means cycle redundancy check, CRC) when each of network devices connects to the Ethernet network.

Specifically, FIGS. 3A and 3B illustrate structures of the first authentication packet 400 and the second authentication packet 500, and the information and value is not limited to the description mentioned above, and also adaptive to the same or similar type of packet structure. Subsequently, the values of the FIGS. 3A and 3B only are assumption description, and two values respectively having the authentication type information, the authentication protocol information and the digest information should be the same as each other when the first network device 210 authenticates with the second network device 220 each other.

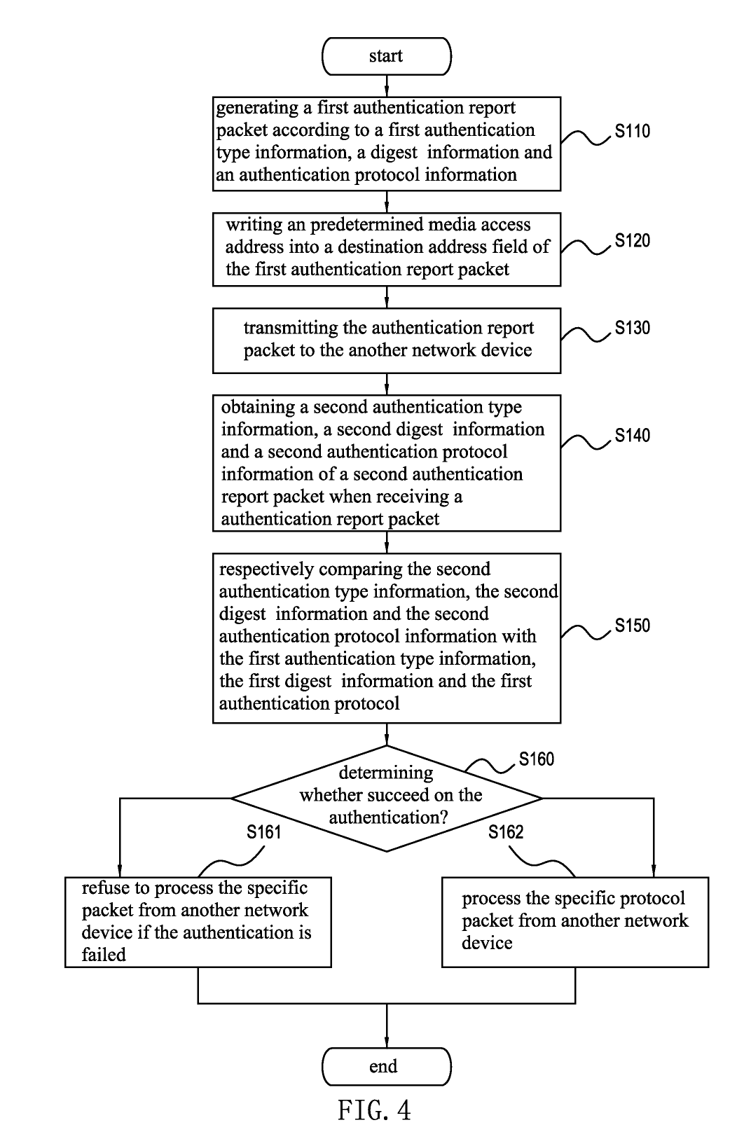

FIG. 4 is a flow chart illustrating the authentication method of the network device according to one embodiment of the present invention. The method mainly applies in the authentication step of each network device when any Layer 2 network device connects to other Layer 2 network devices. In the embodiment, take the first network device 210 connected to the second network device 220, for an example, it describes the authentication steps when the first network device connects to the second network device, and the steps describes as follows:

S101: generating a first authentication report packet according to a first authentication type information, a digest information and an authentication protocol information. In the step, the first verification module 211 of the first network device 210 firstly reads the authentication report information of the first storing unit 212 (that means the first authentication type information 241, the first digest information 261 and the first authentication protocol information 251), and builds a first authentication report packet 400 according to the authentication report information. In the step, it further comprises writing the first authentication type information 241, the first digest information 261 and the first authentication protocol information 251, which are stored in the first storing unit 212, into the authentication type field, the digest field and the authentication protocol field of the first authentication report packet 400.

S120: writing a predetermined media access control address into a destination address field of the first authentication report packet. In the step, the verification module 211 of the first network device 210 write the predetermined MAC address to the destination address field of the authentication packet for performing to process the authentication packet after the network device receives the authentication packet.

S130: transmitting the authentication report packet to the another network device. In the step, the network device 210 transmits the first authentication report packet 400 to the second network device 220 via the first packet unit 220.

S140: obtaining a second authentication type information, a second digest information and a second authentication protocol information of a second authentication report packet when receiving a authentication report packet. In the step, when the packet unit in the first network device 210 receives the second authentication report packet 500 from the second network device, the first verification module 211 reads the authentication type field, the digest field and the authentication protocol field of the second authentication report packet 500 for obtaining the second authentication type information 242, the second digest information 262 and the second authentication protocol information 252 and the like.

S150: respectively comparing the second authentication type information, the second digest information and the second authentication protocol information with the first authentication type information, the first digest information and the first authentication protocol. In the step, the first verification module 211 of the first network device 219 may respectively compare the second authentication type information 242, the second digest information 262 and the second authentication protocol information 252 generated from S140 with the first authentication type information 241, the first digest information 261 and the first authentication protocol information 251 stored in the storing unit 212 so as to determine whether each information matches or not.

S160: determining whether succeed on the authentication according to the comparing result. In the step, it determines whether succeed on the authentication of the network transmitting the second authentication report packet according to the comparing result based on the step 150, so as to ensure the succeeding transmitted specific protocol packet from the network device. It performs the step 161 to refuse to process the specific packet from another network device if the authentication is failed. Otherwise, it performs the step 162 to process the specific protocol packet from another network device. Specifically, the step further comprises the authentication is determined as successful when the comparing result is match. Otherwise, the authentication is determined as failed when the comparing result is mismatch.

Therefore, the objective elements of the succeed authentication in the present embodiment is that the three fields of the authentication type, the digest and the authentication protocol must be matched, and the authentication is failed and then it restarts to perform the authentication when one of the three field is changed.

In the embodiment, before the authentication is successful, the network device may transmit the authentication report packet itself every period of intervening time (for example, one minute) if the network device does not receive the authentication report packet from another network device. Additionally, when starting to transmit the authentication report packet at a particular time, it may detect the new network device connected to be enabling, or when receiving the authentication report packet from another network device, it corresponds to transmit the authentication report packet itself.

In addition, the first network device and the second device are not set as the receiving terminal or the transmitting terminal in the embodiment and it only ensure the authentication report packet having the usage weight between the receiving terminal and the transmitting terminal, the first network device and the second network device may transmit data each other.

Beside, the present invention provides an authentication mechanism applied in L2GAP. It may use the network device or system disclosed by the present invention to respectively set per port or per system, and the network equipments connected the network device must be authenticated and then the network device may normally transmit, receive and process the Layer 2 protocol packet from the network equipments. Therefore, it may avoid that some one applies the unallowable network devices to use the specific layer 2 protocol packet to damage or malicious attack the network device or system.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A network device configured to connect another network device, comprising:
a storing unit, for storing an authentication type information, a digest information and an authentication protocol information;
a packet unit, for transmitting a first authentication report packet to the another network device, and receiving a second authentication report packet from the another network device; and
a verification module, for obtaining the authentication type information, the digest information and the authentication protocol information from the storing unit, and then respectively writing the authentication type information, the digest information and the authentication protocol information into an authentication type information field, a digest information field and an authentication protocol information field when the network device configured to connect the another network device, and comparing information of the authentication type information field, the digest information field and the authentication protocol information field of the second authentication report packet with the authentication information, the authentication information and the authentication protocol information in the storing unit so as to determine whether process a specific protocol packet from the another network device.

2. The network device of claim 1, further comprising:
a user interface, for inputting the authentication type information and the authentication protocol information of the network device.

3. The network device of claim 1, wherein the digest information is obtained by calculating a predetermined code by using a calculation manner indicated by the authentication type information.

4. The network device of claim 3, wherein the predetermined code is a pre-shared key, and the authentication type information is a message-digest algorithm.

5. The network device of claim 1, wherein the first authentication report packet and the second authentication report packet respectively include a destination address field, and wherein the destination address field is an unused media access control address, which is selected from broadcast media access control addresses and multicasting media access control addresses.

6. The network device of claim 1, wherein the specific protocol packet is Spanning Tree Protocol (STP), Link Aggregation Control Protocol (LACP), GARP VLAN registration protocol (GVRP) or Link Layer Discovery Protocol (LLDP).

7. The network device of claim 1, wherein the authentication model determines whether the information in the authentication type information field, the digest information field and authentication protocol information field of the second authentication report packet each matches the authentication type information, the digest information and the authentication protocol information of the storing unit, it determines whether the specific protocol packet subsequently transmitted from the another network will be process.

8. The network device of claim 7, wherein once the authentication type information, the digest information and the authentication protocol information of the storing unit are changed, the authentication model reproduces the authentication report packet and compares the second authentication report packet transmitted from the another network again.

9. The network device of claim 1, wherein when the information in the authentication type information field, the digest information field and authentication protocol information field of the second authentication report packet each matches with the authentication type information, the digest information and the authentication protocol information of the storing unit, the authentication model will determine that the specific protocol packet subsequently transmitted from the another network device will be refused to be processed once anyone information is failure.

10. The network device of claim 1, wherein when the authentication model does not obtain the second authentication report packet from the another network device, it periodically generates and transmits the first authentication report packet to the another network device via the packet unit.

11. An authentication method adapted for an authentication of an another network device of a second layer in OSI layers, which method comprising:
generating a first authentication report packet according to a first authentication type information, a digest information and an authentication protocol information;
writing an predetermined media access control address into a destination address field of the first authentication report packet;
transmitting the authentication report packet to the another network device;
obtaining a second authentication type information, a second digest information and a second authentication protocol information of a second authentication report packet when receiving an authentication report packet;
respectively comparing the second authentication type information, the second digest information and the second authentication protocol information with the first authentication type information, the first digest information and the first authentication protocol; and
determining whether the authentication of the another network device is success or failure according to the comparing result.

12. The authentication method of claim 11, further comprising:
inputting the first authentication type information and the second authentication type information via a user interface.

13. The authentication method of claim 12, further comprising:
calculating a predetermined code by a calculation manner indicated by the authentication type information so as to obtain the digest information.

14. The authentication method of claim 13, wherein the predetermined code is a network Pre-shared key, and the authentication type information is a message-digest algorithm.

15. The authentication method of claim 11, wherein the first authentication report packet and the second authentication report packet respectively include a destination address field, and wherein the destination address field is written with an unused media access control address which is broadcast or multicast type.

16. The authentication method of claim 11, wherein the specific protocol packet is Spanning Tree Protocol (STP), Link Aggregation Control Protocol (LACP), GARP VLAN Registration Protocol (GVRP) or Link Layer Discovery Protocol (LLDP).

17. The authentication method of claim 11, further comprising:
generating the first authentication report packet following with an Ethernet network packet structure.

18. The authentication method of claim 11, wherein the step of determining whether the authentication of the another network device is success or failure according to the comparing result further comprises:
when the information in the authentication type information field, the digest information field and authentication protocol information field of the second authentication report packet each matches the authentication type information, the digest information and the authentication protocol information of the storing unit, processing the specific protocol packet subsequently transmitted from the another network device.

19. The authentication method of claim 11, wherein the step of determining whether the authentication of the another network device is success or failure according to the comparing result further comprises:
when the information in the authentication type information field, the digest information field and authentication protocol information field of the second authentication report packet does not each match the authentication type information, the digest information and the authentication protocol information of the storing unit, refusing to process the specific protocol packet subsequently transmitted from the another network device.

20. The authentication method of claim 11, wherein the step of transmitting the first authentication report packet to the another network device further comprises:
periodically transmitting the first authentication report packet until the second authentication report packet is obtained.
